(19) United States
(12) Patent Application Publication
(10) Pub. No.: US 2026/0187341 A1
(43) Pub. Date: Jul. 2, 2026

(54) THRESHOLD-BASED TRANSACTION EXTRACTION FROM WEB PAGES UTILIZING AN ADAPTIVE THRESHOLD

(71) Applicant: Intuit Inc., Mountain View, CA (US)

(72) Inventors: Aleksandr KIM, Tel Aviv (IL); Itay MARGOLIN, Petah Tikva (IL); Guy SHTAR, Nes-Ziona (IL)

(21) Appl. No.: 19/005,168

(22) Filed: Dec. 30, 2024

(51) Int. Cl. G06F 40/117; G06F 40/177

(52) U.S. Cl. CPC G06F 40/117; G06F 40/177

(57) ABSTRACT

Certain aspects of the disclosure provide techniques for web page content extraction. A method generally includes: extracting markup language elements from a first web page; generating a first plurality of probabilities that the markup language elements represent a plurality of transactions based on, for each respective markup language element: determining markup language features associated with the respective markup language element; and generating a probability that the respective markup language element represents a transaction by processing, with a first machine learning (ML) model, the markup language features; generating a probability density distribution for the first web page based on the first plurality of probabilities; extracting distribution features associated with the probability density distribution; generating a transaction probability threshold associated with the first web page by processing, with a second ML model, the distribution features; and identifying a subset of the markup language elements having respective probabilities above the transaction probability threshold.

### BACKGROUND

### Field

Aspects of the present disclosure relate to web page content extraction.

### Description of Related Art

A “web page” refers to a document on the World Wide Web, which may be rendered in a web browser for various purposes. For example, a web page may include content such as text, images, videos, links, forms, and/or other multimedia elements to provide information, enable online transactions, and/or offer interactive content, among others. The structure and organization of a web page's content may be defined using a markup language (e.g., a set of rules or instructions). Specifically, a markup language may use tags (or code) to define markup language elements within a web page, which may control the web page's presentation, structure, and/or behavior. In a markup language, “tags” may represent the structural components of a document, such as <h1> for headings, <p> for paragraphs, <b> for bold text, etc. “Markup language elements” may be formed by tags and encompass both opening and closing tags along with any content between the tags (e.g., the markup language element “<p> My first paragraph <p>” includes an opening tag <p>, a closing tag <p>, and content “My first paragraph”).

Common example markup languages include Hypertext Markup Language (HTML), eXtensible Markup Language (XML), and Markdown. HTML generally includes code that is used to structure a web page and its content. For example, a series of markup language elements, such as “HTML elements,” may be used to structure web page content within a set of paragraphs, as a list of bulleted points, using images and/or data tables, with bolded text, with mixed size fonts, and/or the like. Example HTML elements may include a <body> element defining a web page's body, a <h1> element defining a heading, a <table> element defining tabular data, a <tr> element defining a row of cells in a table, etc.

Web page content may be regularly extracted and used for a wide range of applications, including financial analysis, data aggregation, content monitoring, academic research, market research, and/or the like. As an illustrative example, in some applications, web page content extraction techniques may be used to automatically extract transaction details, such as amount, date, description, buyer, seller, and/or other relevant information, directly from one or more HTML web pages (e.g., a user's list of transactions from their online bank account, etc.). As used herein a “transaction” may refer to an instance involving the exchange of good(s), service(s), and/or financial asset(s) for money and/or other compensation. The extracted transaction information may be used for data quality monitoring (e.g., are the number of transactions associated with a particular seller greater than what is normal or expected for that seller, is the total amount of the transactions within a normal or expected range or are one or more transactions missing, etc.), to gain valuable insights into a user's spending patterns, detect fraudulent activity, and/or identify corresponding transactions and invoices for transaction-invoice matching, among other uses.

Web page content extraction techniques may generally involve (1) obtaining markup language code associated with a particular web page, (2) “parsing” or analyzing the markup language code to understand the web page's structure and identify the position of desired data, such as based on locating specific tags and/or other identifiers included in the markup language code, and (3) “extracting” or pulling out the desired data from the web page. The extracted content may be used for one or more of the aforementioned applications.

Scripts may be commonly used to perform such parsing and extraction when working with web page data. A “script” is a sequence of instructions, such as created by a developer, that that may be interpreted or executed to automate task(s) and/or carry out specific function(s). With respect to web page parsing and extraction, scripts may automate the process of reading, interpreting, and extracting useful content from the markup language code of a web page.

### SUMMARY

Certain aspects provide a method of markup language element classification, comprising: extracting a first plurality of markup language elements from a first web page; generating a first plurality of probabilities that the first plurality of markup language elements represent a plurality of transactions based on, for each respective markup language element of the first plurality of markup language elements: determining a first plurality of markup language features associated with the respective markup language element; and generating a probability that the respective markup language element represents a transaction by processing, with a first machine learning (ML) model, the first plurality of markup language features; generating a first probability density distribution for the first web page based on the first plurality of probabilities; extracting a first plurality of distribution features associated with the first probability density distribution; generating a first transaction probability threshold associated with the first web page by processing, with a second ML model, the first plurality of distribution features; and identifying a subset of the first plurality of markup language elements having respective probabilities above the first transaction probability threshold.

Certain aspects provide a method of training a first machine learning (ML) model, comprising: obtaining a plurality of training data instances associated with a plurality of web pages, wherein each respective training data instance associated with a respective web page comprises: a training input comprising a plurality of features associated with a probability density distribution generated for the respective web page; and a training output comprising a transaction probability threshold associated with the respective web page; for each respective training data instance of the plurality of training data instances: training the first ML model to generate a predicted transaction probability threshold for the respective web page and thereby generate the predicted transaction probability threshold based on the training input; comparing the predicted transaction probability threshold with the training output; and modifying one or more parameters of the first ML model based on the comparison.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system that includes a web page content extractor and a web page threshold adapter.

FIG. 2 depicts an example workflow for web page content extraction.

FIGS. 3A-3B depict an example web page and corresponding markup language elements.

FIG. 4 depicts an example workflow for training a machine learning model to predict a transaction probability threshold for a web page.

FIG. 5 depicts an example probability density distribution and its corresponding transaction probability threshold.

FIG. 6 depicts example generation of a training data instance, such as used for training a machine learning model to predict a transaction probability threshold for a web page.

FIG. 7 depicts an example method for markup language element classification, such as for web page content extraction.

FIG. 8 depicts an example method for training a machine learning model to predict a transaction probability threshold for a web page.

FIG. 9 depicts an example processing system with which aspects of the present disclosure can be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

As above, scripts may be used to extract information from web pages. However, a script may be ineffective for parsing and extracting content from web pages when the web pages (1) use varying markup language structure and tags, (2) have various markup language complexities, and/or (3) have varying availability of content in the markup language code. For example, different web pages may include similar content, but within different tags, such as a first web page that uses <div> tags to define distinct sections of the first web page and a second web page that alternatively uses <section> tags to essentially perform the same function but for the second web page (e.g., a <section> tag may be used to define distinct sections of the second web page). Further, different web pages may have different complexities, such as nested elements (e.g., a nested element may include an element contained within another element), forms, tables, multimedia, etc., to handle and/or may not make available content in the raw markup language code (e.g., instead, additional tools or scripts may be needed to load the content before it can be parsed and extracted). Due to factors such as these, creating a single script that is able to effectively parse information, despite all the variations that are possible across web pages, presents a technical problem for which no current solution exists.

Accordingly, a developer may need to create multiple scripts to enable accurate parsing and extraction of relevant data from multiple web pages. Creating and maintaining multiple scripts, as well as keeping the scripts updated and free from bugs and/or issues, is tedious, time-consuming, and often prone to technical errors. Further, as the number of web pages that need to be extracted increases, the number of scripts needed to parse and extract information from these variant web pages may grow proportionally, leading to even more performance issues. Accordingly, there is a need for a technical solution for parsing and extracting content from a web page that may be universally applied to any web page.

Aspects described herein overcome the aforementioned technical problems and improve upon the state of the art by providing an automated solution for web page parsing and extraction, which identifies markup language elements from a web page that are desired for extraction based on utilizing an adaptive threshold associated with the web page. As described in detail below, the adaptive threshold may be used as a decisive point for identifying markup language elements that include desired content. In certain aspects, the automated solution may be used to perform web page transaction extraction, such as to automatically classify one or more markup language elements from a web page as transactions for extraction (e.g., “transaction elements,” which contain desired transaction information). For example, a first machine learning (ML) model may be used to predict the probability of each markup language element, from a web page, representing a transaction. A subset (e.g., one or more) of the markup language elements having respective probabilities above a transaction probability threshold (e.g., the adaptive threshold), associated with the specific web page, may be confirmed as transaction(s) and further extracted from the web page. For example, the probabilities of the markup language elements representing transactions may be compared to the transaction probability threshold to identify those markup language elements that contain desired transaction information for extraction. The extracted transaction information may be used for one or more of the aforementioned applications, including, for example, financial analysis, data aggregation, data quality monitoring, and/or the like.

According to aspects described herein, the transaction probability threshold associated with the web page may be adapted for the web page. That is, instead of using a fixed transaction probability threshold for identifying markup language elements that represent transactions across web pages, a second ML model may be used to dynamically adjust the transaction probability threshold for the particular web page. For example, the predicted probabilities (e.g., predicted by the first ML model) of the individual markup language elements from the web page may be used to generate a probability density distribution, of the predicted probabilities, for the web page (described in detail below), essentially representing the underlying structure and content of the web page. As an illustrative example, similar markup language elements (e.g., in terms of position on the web page, content, structure, etc.) may have similar probabilities of representing a transaction. A peak of high probabilities in a probability density distribution created for a web page may indicate that the markup language elements associated with the high probabilities, which make up the peak, are likely to represent transactions for the web page. Further, a peak of low probabilities in a probability density distribution created for a web page may indicate that the markup language elements associated with the low probabilities, which make up the peak, are not likely to represent transactions for the web page. Thus, a probability density distribution generated for a web page may help to indicate what type of markup language elements (e.g., such as elements representing transactions) are associated with the web page.

The second ML model may process features associated with the probability density distribution (referred to herein as “distribution features,” which may describe characteristics of the probability density distribution, such as number of peaks, peak values, etc.) to generate the transaction probability threshold associated with the web page. The transaction probability threshold may be different than a transaction probability threshold associated with another web page having a different underlying structure and/or content, but may be similar (or the same as) a transaction probability threshold associated with another web page having a similar (or the same) underlying structure and/or content. That is, the second ML model may be trained to generate similar transaction probability thresholds for web pages associated with similar probability density distributions (or more specifically, similar probability density distribution features), under the assumption that web pages with similar underlying structure and/or content may be associated with similar probability distributions, although the web pages may differ from each other based on their tags, markup language elements, and/or complexities.

The web page content extraction techniques described herein provide significant technical advantages over conventional solutions, such as their ability to be utilized for extraction of content from any web page, irrespective of its underlying structure. This technical effect overcomes the technical problem of limited data processing capability when using web page-specific scripts for extracting information from multiple web pages. The web page content extraction techniques described herein further help to achieve improved content extraction accuracy. For example, the web page content extraction techniques may initially predict the probability of a markup language element representing desired content (e.g., a transaction) and then further use a threshold to check whether the prediction is valid. The use of the threshold helps to control the confidence level required to consider a markup language element as an element that contains desired content for extraction. Thus, the threshold may help to improve the identification of desired content for extraction, reducing false positives initially predicted to contain desired content, as well as false negatives initially predicted not to contain desired content. Accordingly, more comprehensive and accurate extraction from web pages may be achieved.

Use of web page-specific thresholds when identifying desired content for extraction also provides further technical benefits. For example, leveraging specific features derived for each web page to dynamically adjust a threshold associated with the web page, which may be used for extraction of content from the specific web page, helps to optimize performance of the extraction for the specific web page. Further, the web page-specific thresholds used for web page content extraction may allow for the use of a single universal extraction solution across multiple web pages, even when the web pages have variable structure and/or complexities.

Example System Including a Web Page Content Extractor and a Web Page Threshold Adapter

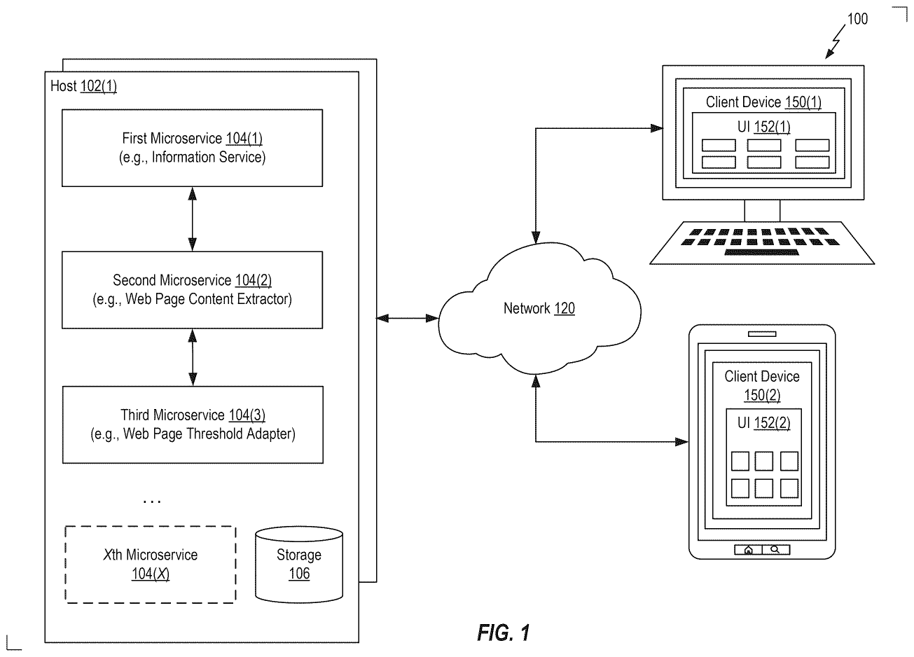

FIG. 1 depicts an example system 100 that includes a web page content extractor and a web page threshold adapter. In certain aspects, the web page content extractor and the web page threshold adapter may each be implemented as a software-defined service (e.g., in some cases, a cloud-native software-defined service), also referred to herein as “a microservice 104.” Generally, microservices 104 are loosely-coupled and independently deployable services (or software) that may make up an application. Microservices 104 may enable segmented, granular level functionalities within a larger system infrastructure.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104” and individually referred to herein as a “microservice 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface (UI) 152(1), 152(2), respectively, which may be used to communicate with, at least, a first microservice 104(1), a second microservice 104(2), and/or a third microservice 104(3) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, the first microservice 104(1), the second microservice 104(2), and the third microservice 104(3). In certain aspects, the first microservice 104(1) implements an information service 104(1), which is any network 120 accessible service that maintains financial data, medical data, personal identification data, and/or other data types. For example, the information service 104(1) may include QuickBooks® and its variants made commercially available by Intuit® of Mountain View, California.

In certain aspects, the second microservice 104(2) implements a web page content extraction service 104(2). The web page content extraction service 104(2) (or “web page content extractor 104(2)”) may be a service used to perform web page content extraction techniques. For example, the web page content extractor 104(2) may (1) parse markup language code to understand a web page's structure and identify the position of desired data within the web page and (2) extract the desired data from the web page. In certain aspects, a web page from which content is extracted may include a web page provided via the information service 104(1). In certain aspects, the web page content extractor 104(2) may be used for transaction extraction to identify markup language elements associated with a web page that represent a transaction (“transaction elements”) and extract content related to these markup language elements. In certain aspects, the web page content extractor 104(2) may identify transaction elements for a web page based on a transaction probability threshold determined for the web page by a web page threshold adaptation service.

For example, in certain aspects, the third microservice 104(3) implements a web page threshold adapter service 104(3). The web page threshold adapter service 104(3) (or “web page threshold adapter 104(3)”) may be a service used to determine web page thresholds for various web pages. For example, in certain aspects, the web page threshold adapter 104(3) may determine transaction probability thresholds for various web pages. The transaction probability threshold associated with a web page may represent a probability value that needs to be satisfied (e.g., exceeded) for a markup language element of the web page to be classified (e.g., as a final classification) as a transaction element (or representing a transaction in web page). In certain aspects, the web page threshold adapter 104(3) communicates, to the web page content extractor 104(2), a web page threshold determined for a web page, such that the web page extractor 104(2) may use the web page threshold when extracting content from the particular web page.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other aspects may include more or less hosts 102 and/or client devices 150, and client devices 150 may use any combination of microservices 104 on any host 102 where microservices 104 are deployed.

### Aspects Related to Web Page Content Extraction Utilizing an Adaptive Threshold

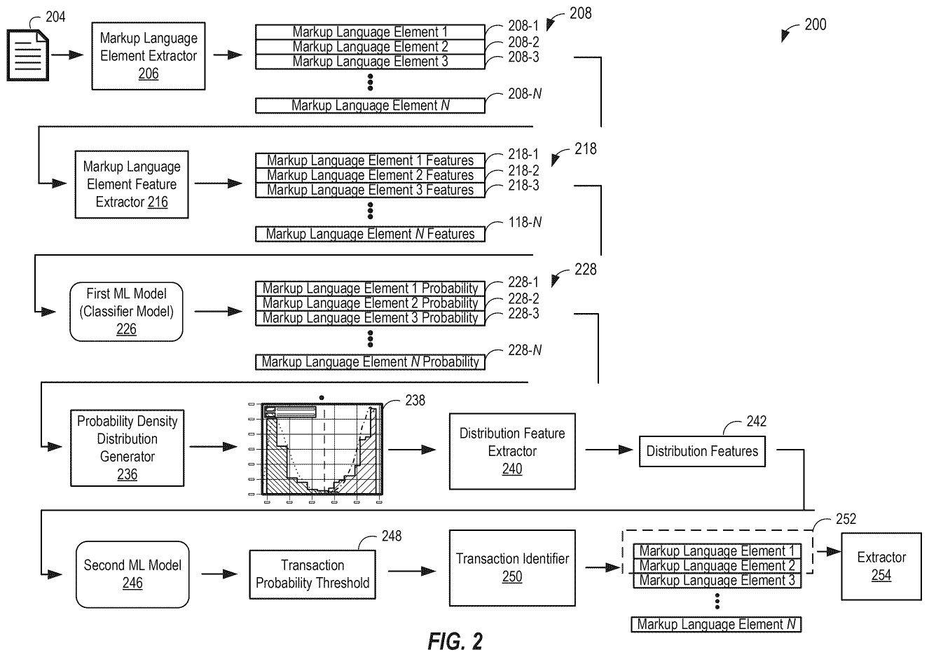

FIG. 2 depicts an example workflow 200 for web page content extraction. More specifically, workflow 200 may be used to extract transaction information from a web page 204 based on utilizing a transaction probability threshold 248 (e.g., an adaptable threshold) associated with the web page 204. The transaction probability threshold 248 associated with the web page 204 may be a threshold that is adjusted based on, at least, the underlying structure and markup language elements 208 that make up the web page 204 (e.g., as described in more detail below). Although workflow 200 is described herein with respect to threshold-based transaction extraction from web page 204, it is noted that in some other examples, workflow 200 may be similarly used to perform other types of web page extraction to extract other content (e.g., personal data, tables, headers, etc.) from one or more web pages.

In this example, web page 204 is a document that may be rendered in a web browser. Web page 204 may include content, such as transaction information for one or more pending, completed, or future transactions. Example transaction information displayed via the web page 204 may include transaction details, such as transaction amount, transaction date, transaction type, transaction description, a buyer associated with a transaction, a seller associated with a transaction, and/or other relevant information, related to the transaction(s). As an illustrative example, in certain aspects, web page 204 is a web page used to display multiple bank transactions, such as cash withdrawals, deposits, debit card charges, wire transfers, etc., associated with a user's bank account.

The structure and organization of the transaction information displayed via web page 204 may be defined using a markup language. The transaction information may be associated with at least a subset of the markup language elements 208 that make up web page 204. For example, a markup language element 208-1 (“markup language element 1” shown in FIG. 2) from web page 204 may comprise “<td> $38.99 <td>,” where the content “$38.99” associated with markup language element 208-1 is related to a withdrawal (e.g., an example transaction) made by a user on Jan. 1, 2024. In HTML, a <td>tag is a tag used to define a data cell in a table. In certain aspects, markup language elements 208 are HTML elements (e.g., where HTML code is used to structure web page 204); however, in certain other aspects, markup language elements 208 may be XML elements, Markdown elements, and/or the like.

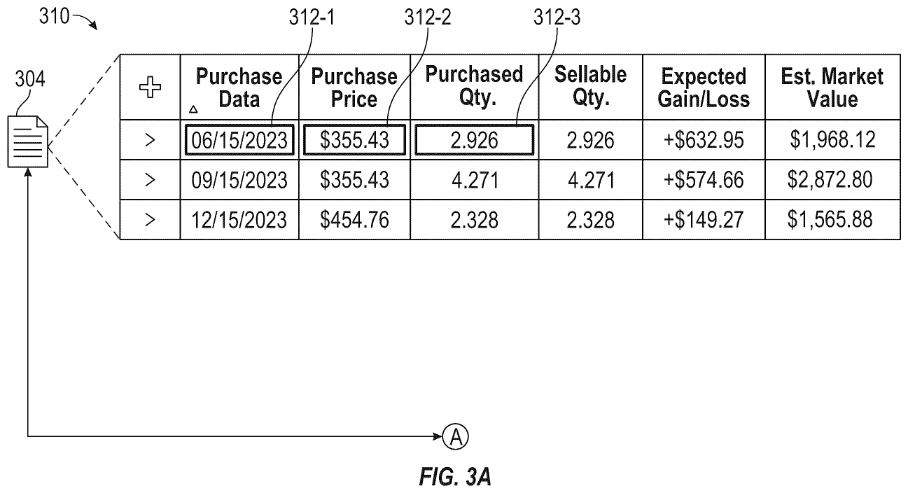

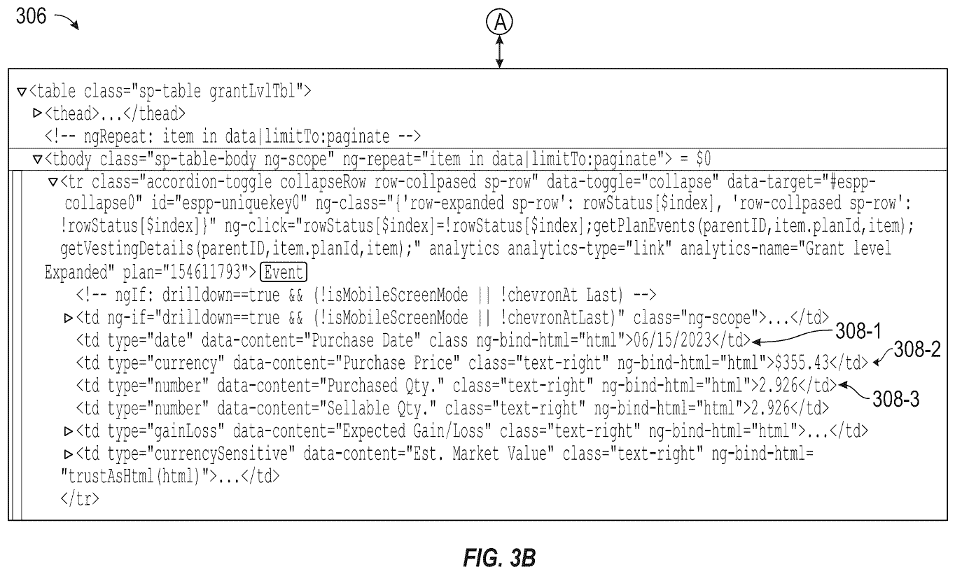

FIGS. 3A-3B depict an example web page 304 and its corresponding markup language elements 308. Web page 304 may be one example of web page 204 depicted and described with respect to FIG. 2, for which transaction information may be extracted from.

As shown in FIG. 3A, web page 304 may include content such as transaction information 310 organized in a table format for display via web page 304. The transaction information 310 may include details for at least three transactions, and more specifically three sales (e.g., items and/or services purchases by consumer(s)), as shown in FIG. 3A. Transaction details for each respective transaction in this example may include information about a date of the respective transaction, a purchase price associated with the respective transaction, a purchased quantity associated with the respective transaction, a sellable quantity associated with the respective transaction, an associated expected gain/loss, and an associated estimated market value. For example, transaction information for a first transaction may include (1) a transaction date of “06/15/2023,” (2) a purchased price of “$355.43,” and (3) a purchased quantity of “2.926,” among other details. The transaction date, transaction purchased price, and transaction purchased quantity for the first transaction may each be referred to herein as “content” associated with web page 304 (e.g., content 312-1, content 312-2, and content 312-3, respectively).

HTML code 306 (shown in FIG. 3B) may define the structure and organization of content displayed via web page 302, including transaction information 310. In particular, web page 302 may be represented as multiple HTML elements in HTML code 306. For example, a first HTML element 308-1 may be provided in HTML code 306 to specify the organization and layout of content 312-1 (“06/15/2023”) for web page 304, a second HTML element 308-2 may be provided in HTML code 306 to specify the organization and layout of content 312-2 (“$355.43”) in web page 304, and a third HTML element 308-3 may be provided in HTML code 306 to specify the organization and layout of content 312-3 (“2.926”) in web page 304.

In certain aspects, workflow 200 of FIG. 2 may be used to extract the table of transaction information 310 included in web page 304, such as based on analyzing the HTML elements included in HTML code 306 associated with web page 304. In certain aspects, the extracted transaction information 310 may be displayed to a user and/or used in one or more applications.

Returning to FIG. 2, workflow 200 begins by obtaining web page 204 (e.g., such as web page 304 depicted and described with respect to FIGS. 3A-3B). A markup language element extractor 206 then extracts markup language elements 208-1 through 208-N (collectively referred to herein as “markup language elements 208” and individually referred to herein as “markup language element 208”), where N is an integer greater than zero, from web page 204. In certain aspects, markup language element extractor 206 comprises a collection of code used to extract data from files, such as HTML files, XML files, etc. As an illustrative example, in certain aspects, markup language element extractor 206 comprises a Python® library, such as the BeautifulSoup library, which includes an algorithm for extracting markup language elements, their paths, their content, and/or the like from web pages.

In certain aspects, markup language elements 208 extracted from web page include a majority of, or all of, the markup language elements associated with web page 204. As described herein, a markup language element is a single, identifiable part of a web page defined within a markup language, typically indicated by multiple tags, including at least an opening tag and a closing tag. A markup language element may be identified by its respective path of tags, as multiple markup language elements may share the same tags. In certain aspects, it may be possible to identify a markup language element based on all tags that are represented in the markup language element's path. For example, a markup language element associated with path “body/div/div/table/tr/td” may indicate that the markup language element is within <td> tags, its parent markup language elements are within <tr> tags, its grandparent markup language elements are within <table> tag, etc. Additional information related to markup language paths, parents, etc. is provided below.

In certain aspects, at least one of the extracted markup language elements 208 represents a transaction. A markup language element 208 may represent a transaction where the element includes content associated with one or more transactions. A transaction may be a localized part of a web page that includes information about a particular transaction. A transaction on a web page may be presented as a row in a table via the web page, presented as a whole table via the web page, presented via the web page without tables, and/or the like.

Workflow 200 then proceeds with a markup language element feature extractor 216 extracting markup language features 218 associated with markup language elements 208. In certain aspects, respective markup language features 218 may be extracted for each markup language element 208. For example, markup language features 281-1 may be extracted for markup language element 208-1, markup language features 218-2 may be extracted for markup language element 208-2, markup language features 218-3 may be extracted for markup language element 208-3, and so on. Thus, markup language features 218-1 through 218-N (collectively referred to herein as “markup language features 218” and individually referred to herein as “markup language features 218”) may be extracted.

Example markup language features 218 associated with a single markup language element 208 may include text (e.g., the content) associated with the markup language element 208; a type of the respective markup language element 208 (e.g., type may be based on the visible text and/or pattern associated with the respective markup language element 208 via the web page, such as “amount,” “date,” etc.); a number of parent/grandparent/etc. elements associated with the markup language element 208; a number of sibling elements associated with the markup language element 208; a number of child/grandchild/etc. elements associated with the markup language element 208; a depth of the markup language element 208; a markup language path or an embedding of the markup language path associated with the markup language element 208; or a table header corresponding to the markup language element 208 (e.g., where the markup language element 208 is included in a table based on its associated tags). An order of markup language elements may be used to determine a table header (e.g., a first markup language element in header (th.td[0]) may correspond to the first markup language element in row (tr.td[0], etc.).

In certain aspects, markup language code (e.g., HTML code) may be hierarchically represented in a tree structure (e.g., an HTML document tree). Each markup language element 208 included in the tree structure may be represented as a node. Each markup language element 208 (e.g., node) may include a parent markup language element 208 (excluding a root node of the tree), and in some cases, child and/or sibling markup language element(s) 208. A “parent markup language element 208” is an element, represented by a node in the tree structure, that is directly above and connected to another markup language element, representing as another node in the tree structure. A “sibling markup language element 208” is an element, represented by a node in the tree structure, that shares a same parent markup language element 208/node as another markup language element, represented as another node, in the tree structure. The “depth” of a markup language element 208 may be equal to a number of edges present in a path from a root node in the tree structure to the node representing the markup language element 208 in the tree structure. An example markup language element 208 that has depth may include a markup language element 208 with a markup language path (e.g., an xpath) of body/div/div/table/tr. A “markup language path” may refer to an address associated with a markup language element 208. A “markup language path” may be represented as a set of tags, such as “body/div/div/table/tr” (e.g., having a depth of five or a depth of 4four, where “body” has a depth of zero or not one). In certain aspects, a “markup language path” associated with markup language element 208 may be extracted using a Python® library, such as the BeautifulSoup library. In certain aspects, an embedding of a markup language path may be created using a bag of words applied to a sequence of tags associated with the markup language path. For example, if a tag is present, a “1” may be used at a corresponding place, otherwise “0” may be used (e.g., body/table—[1,1,0,0,0], body/table/th/td—[1,1,1,1,0],body/div/div—[1,0,0,0,1], etc.).

Workflow 200 then proceeds with a first ML model generating probabilities 228 for the markup language elements 208. Each probability 228 may represent a probability that a corresponding markup language element 208 represents a transaction. For example, the first ML model may generate a probability 228-1 for markup language element 208-1, a probability 228-2 for markup language element 208-2, a probability 228-3 for markup language element 208-3, and so on. Thus, probabilities 228-1 through 228-N (collectively referred to herein as “probabilities 228” and individually referred to herein as “probability 228”) may be generated.

A probability 228 generated by the first ML model for a markup language element 208 may represent a probability that the markup language element 208 represents a transaction. The first ML model may generate this probability for the markup language element 208 based on processing markup language features 218 extracted for the markup language element 208. Some markup language features 218, such as a number of markup language element children being equal to three or five, visible text associated with a markup language element comprising a data, and/or visible text associated with a markup language element comprising an amount, may increase the probability that a markup language element 208 represents a transaction, while some other markup language features 218, such as a number of markup language element children being equal to zero or more than ten and/or no visible text being associated with a markup language element, may decrease the probability that a markup language element 208 represents a transaction.

In certain aspects, the first ML model is a classifier model used to classify markup language elements 208 into different categories based on their corresponding markup language features 218. For example, the first ML model may be configured to classify a markup language element 208 as a transaction element or not (e.g., example categories). For example, the first ML model may be configured to return category predictions (e.g., a prediction that a markup language element (1) is a transaction element or (2) is not a transaction element) and/or predicted probabilities for these category predictions (e.g., a prediction of a 20% probability that the markup language element 208 is a transaction element and/or a prediction of an 80% probability that the markup language element 208 is not a transaction element).

Workflow 200 then proceeds with a probability density distribution generator 236 generating a probability density distribution 238 for the web page 204. For example, probability density distribution generator 236 may perform probability density estimation based on the probabilities 228 predicted for markup language elements 208 (e.g., associated with web page 204) to generate the probability density distribution 238. As used herein, “probability density estimation” (or simply “density estimation”) is a statistical technique that uses observed data to estimate a probability distribution function (PDF) for a continuous random variable, or a function that describes the likelihood of the continuous random variable having a particular value within a range of values.

Here, the probability density distribution 238 may provide a visual representation of a PDF curve, where the PDF curve represents the likelihood (e.g., density) of a continuous random variable having a probability 228 value within a range of possible probability 228 values (e.g., values representing the probability that a markup language element 208 represents a transaction). The probability of a random variable falling in a particular range of probability 228 values may be determined based on the area under the PDF curve over that range of probability 228 values.

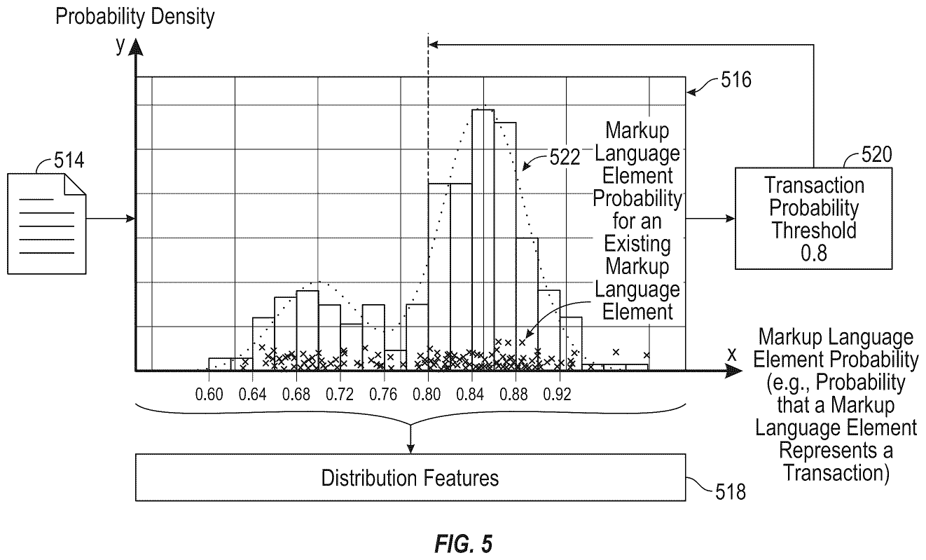

One example probability density distribution 238 that may be generated by probability density distribution generator 236 for web page 204 is depicted and described in detail below with respect to FIG. 5. As shown in FIG. 5, the horizontal axis (x-axis) of a probability density distribution 238 may represent probability 228 values of a markup language element 208 representing a transaction. Further, the vertical axis (y-axis) of a probability density distribution 238 may represent the probability density.

In certain aspects, the generated probability density distribution 238 is generated by a kernel density estimate (KDE). Kernel density estimation is the application of kernel smoothing for probability density estimation, i.e., a non-parametric method to estimate the probability density function of a random variable using kernels as weights. A kernel, such as a Gaussian kernel, is generally a positive function controlled by a bandwidth parameter, h. Kernel density estimation works by creating a kernel density estimate (e.g., a plot), which may be represented as a curve or complex series of curves. In certain aspects, the kernel density estimate is calculated by weighting the distance of all the data points in each specific location along the distribution. If there are more data points grouped locally, the estimation is higher. The kernel function is the specific mechanism used to weigh the data points across the data set. The bandwidth, h, of the kernel acts as a smoothing parameter, controlling the tradeoff between bias and variance in the result. For example, a low value for bandwidth, h, may estimate density with a high variance, whereas a high value for bandwidth, h, may produce larger bias. Bias refers to the simplifying assumptions made to make a target function easier to approximate. Variance is the amount that the estimate of the target function will change, given different data. Returning to FIG. 2, workflow 200 then proceeds with a distribution feature extractor

240 extracting distribution features 242 associated with the probability density distribution 238. In certain aspects, distribution features 242 may include plot statistics associated with probability density distribution 238, where “plot statistics” refer to numerical and/or graphical measures that describe and/or summarize the characteristics of probability density distribution 238. For example, distribution features 242 associated with probability density distribution 238 may include a number of peaks included in probability density distribution 238; one or more peak values for peak(s) formed in probability density distribution 238; one or more peak positions (e.g., associated probability 228 value(s)) for peak(s) formed in probability density distribution 238; and/or other extremum feature(s) (e.g., minimums (e.g., such as troughs), maximums, their positions, etc.).

In certain aspects, instead of generating probability density distribution 238 for web page 204, a histogram-based approach may be used to generate a histogram for web page 204, such as based on probabilities 228 predicted for markup language elements 208 (e.g., associated with web page 204). The histogram-based approach may include splitting probabilities 228 into bins. For example, a histogram, for a web page 204, may be calculated with fixed bins. A number of probabilities 228 that fall within each bin may be determined, and these counts may be normalized and used to create the histogram. In such cases where a histogram is created, distribution features 242 may include an embedding (vector) of the histogram. For example, a resulting embedding (vector) may include [0.2, 0.6, 0.15, 0.5, 0.0, 0, 0, 0] for a histogram with one peak near zero. As another example, a resulting embedding (vector) may include [0.0, 0.05, 0.5, 0.05, 0.3, 0.1, 0, 0] for a histogram with two peaks.

In certain aspects, both a histogram and a probability density distribution 238 may be generated for web page 204.

Workflow 200 then proceeds with a second ML model 246 processing distribution features 242 to generate a transaction probability threshold 248 (e.g., generate an “optimal” transaction probability threshold 248, for example, shown as the dashed line corresponding to transaction probability threshold 520 in FIG. 5) for web page 204. Transaction probability threshold 248 may be specific to web page 204. For example, transaction probability threshold 248 may be adapted or adjusted from a default transaction probability threshold value based on at least distribution features 242 (e.g., which are associated with markup language elements 208 that make up web page 204). In certain aspects, transaction probability threshold 248 represents a probability value that needs to be satisfied (e.g., exceeded) for a markup language element 208 of web page 204 to be classified (e.g., as a final classification) as a transaction element (or representing a transaction in web page 204).

In certain aspects, the second ML model 246 is a regression model. Example regression models may include a linear regression model, a random forest regression model, or a gradient boosting regression model, among others.

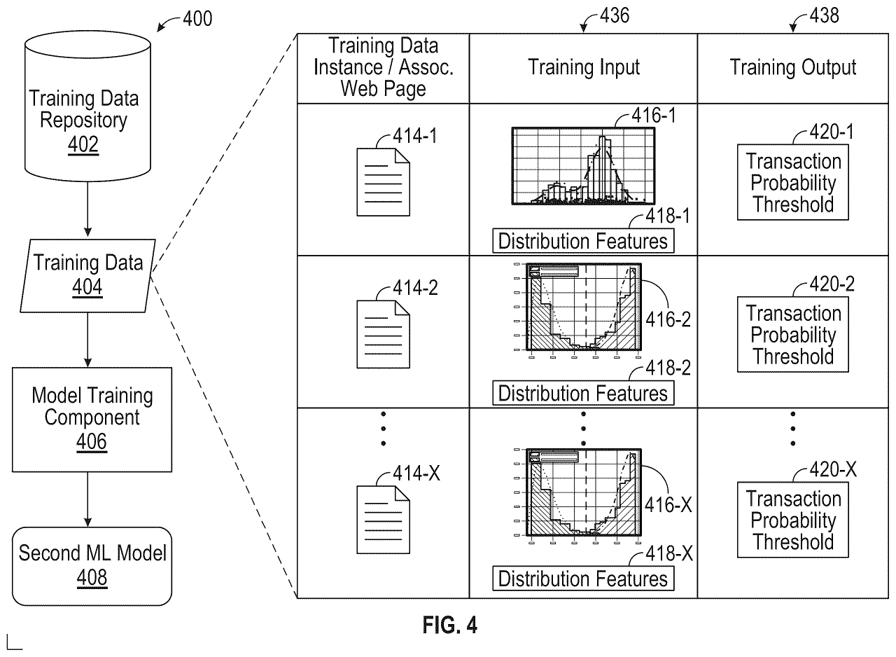

The second ML model 246 may be trained to predict transaction probability thresholds for various web pages, which may be used for classifying markup language elements, associated with the various web pages, as transactions elements or not. For example, the second ML model 246 may be trained to learn the relationships between different underlying web page structures and their optimal transaction probability thresholds. The second ML model 246 may use this knowledge to then generate transaction probability thresholds for other, unseen web pages, at least based on their underlying structure. The second ML model 246 may rely on an underlying assumption that web pages with similar underlying structure may be associated with similar probability density distributions, although the web pages may differ from each other based on their tags, elements, and/or complexities. Thus, based on learning the relationships between different web page structures and their corresponding transaction probability thresholds, the second ML model may be able to predict a transaction probability threshold for any web page. Additional details related to training the second ML model 246 to learn such relationships, including the type of training data used for the training, are depicted and described below with respect to FIG. 4.

In certain aspects, second ML model 246 may be trained with a leave-one-out technique (LOO), leaving out web pages with numerous markup language elements to prevent overfitting and/or help to ensure fair predictions. This is different from classical LOO because here, web pages (e.g., groups of markup language elements) may be dropped instead of individual markup language elements, for which predictions are made.

Workflow 200 then proceeds with a transaction identifier 250 identifying markup language elements 208 associated with respective probabilities 228 that satisfy (e.g., are above) the transaction probability threshold 248. A markup language element 208 with a probability 228 that satisfies the transaction probability threshold 248 (e.g., probability 228≥transaction probability threshold 248) may indicate a transaction element (e.g., represent a transaction, such as based on including transaction details for a transaction, in web page 204). A markup language element 208 with a probability 228 that does not satisfy the transaction probability threshold 248 (e.g., probability 228<transaction probability threshold 248) may not indicate a transaction element. A subset (e.g., one or more) of markup language elements 252 (simply “subset 252”) may be identified by transaction identifier 250 as having associated respective probabilities that satisfy the transaction probability threshold 248. In this example, the subset 252 may include markup language element 208-1 (“markup language element 1” shown in FIG. 2) and markup language element 208-2 (“markup language element 2” shown in FIG. 2). However, in some other examples, the subset 252 may include more or less markup language elements 208 and/or different markup language elements 208.

Workflow 200 then proceeds with an extractor 254 extracting the markup language element(s) 208 included in the subset 252. In certain aspects, text associated with the extracted markup language element(s) 208 may be displayed to a user, such as via a user interface. The displayed text may provide the user with information about the one or more transaction(s) associated with the extracted markup language element(s) 208. In certain aspects, the extracted markup language element(s) 208 may be used for various application, such as for data quality monitoring, to gain valuable insights into a user's financial activity, detect fraudulent activity, and/or perform transaction-invoice matching, among others.

### Aspects Related to Training an ML Model to Predict Transaction Probability Thresholds

FIG. 4 depicts an example workflow 400 for training a second ML model 408 to predict a transaction probability threshold for a web page. For example, in certain aspects, second ML model 408 is an example of second ML model 246 of FIG. 2 and workflow 400 is used to train the second ML model 246 to predict transaction probability thresholds for various web pages (e.g., including transaction probability threshold 248 for web page 204 of FIG. 2).

A model training component 406 may be generally configured to train second ML model 408. For example, in workflow 400, model training component 406 obtains training data 404 from a training data repository 402. Model training component 406 uses training data 404 to train second ML model 408 for transaction probability threshold prediction for web pages having various tags, elements, and/or complexities.

Training data 404 obtained by model training component 406 may include multiple training data instances associated with multiple web pages, such as web pages 414-1 through 414-X, where X is an integer greater than one (collectively referred to herein as “web pages 414” and individually referred to herein as “web page 414”). Each training data instance may include a respective training input 436 and a respective training output 438. A training input 436 for a single training data instance may include distribution features extracted from a probability density distribution generated for a web page 414 associated with the training data instance. A training output 438 for a single training data instance may include a transaction probability threshold associated with a web page 414 associated with the training data instance. The transaction probability threshold may represent a threshold that has been adjusted specifically for the web page 414 associated with the training data instance (e.g., not a fixed transaction probability threshold).

For example, a first training data instance associated with web page 414-1 may include (1) a training input 436 that includes distribution features 418-1 extracted from a probability density distribution 416-1 generated for web page 414-1 and (2) a training output 438 that includes a transaction probability threshold 420-1 (also referred to as “transaction probability threshold label 420-1”), specifically associated with web page 414-2. A second training data instance associated with web page 414-2 may include (1) a training input 436 that includes distribution features 418-2 extracted from a probability density distribution 416-2 generated for web page 414-2 and (2) a training output 438 that includes a transaction probability threshold 420-2, (also referred to as “transaction probability threshold label 420-2”) specifically associated with web page 414-2. An Xth training data instance associated with web page 414-X may include (1) a training input 436 that includes distribution features 418-X extracted from a probability density distribution 416-X generated for web page 414-X and (2) a training output 438 that includes a transaction probability threshold 420-X (also referred to as “transaction probability threshold label 420-X”), specifically associated with web page 414-X. Distribution features 418-1 through 418-X may be collectively referred to herein as “distribution features 418” and individually referred to herein as “distribution features 418.” Transaction probability thresholds 420-1 through 420-X may be collectively referred to herein as “transaction probability thresholds 420” or “transaction probability threshold labels 420” and individually referred to herein as “transaction probability threshold 420” or “transaction probability threshold label 420.”

In certain aspects, web pages from a same provider, and with similar size (e.g., a same amount of transactions and/or other markup language elements), may be associated with a same (or similar) probability density distribution. This is shown in FIG. 4 for web pages 414-2 and 414-X (e.g., based on probability density distribution 416-2 and probability density distribution 416-X). Further, as an illustrative example, two web pages from the same provider with different amounts of transactions may have similar probability density distributions; however, the web page having more transactions may have a higher peak (e.g., higher peak value) corresponding to the transaction probabilities.

One example of the training data instance associated with web page 414-1 is shown in FIG. 5. Specifically, FIG. 5 depicts an example probability density distribution 516 generated for a web page 514 (e.g., based on probabilities of markup language elements associated with web page 514 representing transactions), example distribution features 518 extracted from probability density distribution 516, and a transaction probability threshold 520 that is associated with web page 514 and determined based on probability density distribution 516 and distribution features 518.

Similar to the creation of probability density distribution 238 in workflow 200 of FIG. 2, here, probability density distribution 516 may be generated for web page 514 based on probabilities of markup language elements associated with web page 514 representing transactions (e.g., shown as “x” data points in probability density distribution 516). That is, a PDF curve, such as PDF curve 522, may be estimated based on the markup language element probabilities, where the PDF curve 522 represents the likelihood (e.g., density) of a continuous random variable having a markup language element probability value (e.g., representing the probability that the variable represents a transaction) within a range of possible markup language probability values. The x-axis of probability density distribution 516 may represent markup language element probability values indicating the range of probabilities of a markup language element 208 representing a transaction. Further, the y-axis of probability density distribution 516 may represent the probability density.

Distribution features 518 extracted from probability density distribution 516 may include a number of peaks included in probability density distribution, 516 one or more peak values for peak(s) formed in probability density distribution 516, one or more peak positions (e.g., associated probability markup language element probability values) for peaks formed in probability density distribution 516, an embedding of a histogram, and/or the like. For example, because probability density distribution 516 includes two peaks, distribution features 518 may include information about at least the two peaks associated with the PDF curve 522 in probability density distribution 516.

In certain aspects, a peak formed in a probability density distribution may indicate that there are a large number of markup language elements, associated with a web page, with the same (or very close) probabilities of being a transaction. This means that this large number of markup language elements may have similar position and/or content in the web page. An example case where a peak may be created in a probability density distribution generated for a web page involves a web page that includes a table, such as with transactions, accounts, etc.

Transaction probability threshold 520 associated with web page 514 may be determined based on distribution features 518 extracted from probability density distribution 516. In this example, transaction probability threshold 520 is equal to 0.8 or 80%, indicating that a probability of a markup language element representing a transaction may need to be equal to or greater than 80% for the markup language element to be classified as a transaction element (e.g., a markup language element representing a transaction).

In this example, a training data instance for web page 514 may include a training input and a training output. The training input may include distribution features 518 (e.g., associated with probability density distribution 516), and the training output may include transaction probability threshold 520.

Returning to FIG. 4, one or more of the training data instances may be used to train the second ML model 408. For example, for a single training data instance, the second ML model 408 may process the training input 436 (e.g., distribution features 418) associated with the training data instance to generate a predicted transaction probability threshold for the web page associated with the training data instance. The predicted transaction probability threshold may be compared with the training output (e.g., the transaction probability threshold label 420, which best distinguishes transaction from non-transaction elements) associated with the training data instance, such as to evaluate the similarity of the predicted transaction probability threshold with the transaction probability threshold label 420. Various parameters may be modified for the second ML model 408 based on the comparison for each training data instance.

In certain aspects, evaluating the similarity of a predicted transaction probability threshold, generated for a web page associated with a training data instance, to a transaction probability threshold label 420 associated with the web page is performed using a loss function. The loss function is a mathematical function that measures how well the second ML model 408 is able to predict the desired output, and more specifically, the transaction probability threshold label 420 associated with the web page. A loss value determined using the loss function may be minimized (or equal to zero) when the predicted transaction probability threshold for a web page matches (or is nearly similar to) the transaction probability threshold label associated with the web page. In certain aspects, the loss function is a cross-entropy loss function.

In certain aspects, modifying parameter(s) of the second ML model 408 is performed until all training data instances have been used to train the second ML model 408. In certain aspects, modifying parameter(s) of the second ML model 408 is performed until a training termination condition is reached. One example of a training termination condition includes convergence (e.g., further training may not lead to any significant loss reduction). Another example of a training termination condition includes a number of training steps/epochs reaching pre-determined limit(s) and/or divergence (e.g., further training may cause over-fitting as diagnosable by increasing evaluation loss). Another example of a training termination condition includes a number of contiguous training epochs during which training loss is not decreasing more than a threshold amount (e.g., patience). Other examples of training termination conditions include early stopping criteria, reaching a maximum number of gradient updates, and/or the like.

In certain aspects, training data instances included in training data 404, and used to train second ML model 408, may need to be generated. In certain aspects, the training data instances may be generated for labeled web pages. In certain aspects, the training data instances may be generated for unlabeled web pages. A “labeled web page” may refer to a web page with labeled markup language elements. For example, a labeled web page may include markup language elements that are labeled as “transaction elements” and “not transaction elements.” Alternatively, an “unlabeled web page” may refer to a web page without labeled markup language elements. For example, an unlabeled web page may include markup language elements that do not include any labels (e.g., no indication whether each markup language element represents a “transaction element” or “not a transaction element”).

Generating a training data instance for a labeled web page may include (1) extracting markup language elements from the labeled web page, (2) for each markup language element, generating a probability that the markup language element represents a transaction, (3) generating a probability density distribution for the labeled web page based on the generated probabilities, (4) extracting distribution features associated with the probability density distribution, and (5) creating a training input for the labeled web page comprising the extracted distribution features (e.g., steps 1-4 are similar to steps described in workflow 200 of FIG. 2). The training output for the training data instance, associated with the labeled web page, may be determined based on the probability density distribution and the labels associated with each of the markup language elements. For example, a transaction probability threshold associated with the labeled web page, and used as the training output, may be determined as a threshold that maximizes the results in the maximum number of predicted transaction elements, which are actually transaction elements, being classified as transaction elements. For example, a probability of a first markup language element representing a transaction may be predicted to be equal to 82%. The label for this markup language element indicates that this markup language element is, in fact, a transaction element. Thus, to accurately classify this markup language element as a transaction element, then the transaction probability threshold for the labeled web page may be selected as 82% (0.82) or less, such that this markup language element's probability satisfied the transaction probability threshold and is accurately classified as a transaction element. While in this example, only one markup language element may be considered when selecting the transaction probability threshold for a labeled web page, in other examples, multiple markup language elements, and their corresponding labels, may be used to select the transaction probability threshold for a web page.

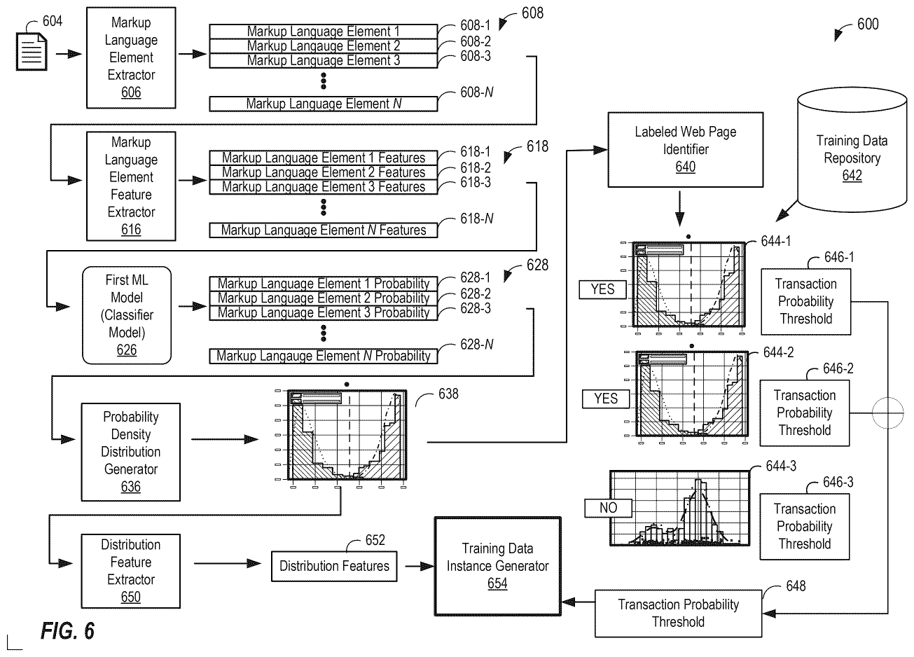

Determining a transaction probability threshold for an unlabeled web page, such as to create a training output for the unlabeled web page, may be less straightforward. Specifically, the “optimal” transaction probability threshold for an unlabeled web page may be unknown, and thus additional techniques may be used to determine the transaction probability threshold for an unlabeled web page. Techniques for determining the transaction probability threshold for an unlabeled web page, such as to create a training data instance for the unlabeled web page, are provided in FIG. 6.

FIG. 6 depicts a workflow 600 for generating a training data instance for an unlabeled web page 604 (simply referred to herein as “web page 604”).

As shown in FIG. 6, workflow 600 includes obtaining web page 604 (e.g., an unlabeled web page); a markup language element extractor 606 extracting markup language elements 608-1 through 608-N (collectively referred to herein as “markup language elements 608” and individually referred to herein as “markup language element 608”); a markup language element feature extractor extracting features 618-1 through 618-N (collectively referred to herein as “features 618” and individually, such as for each markup language element 608, referred to herein as “features 618”) for markup language elements 608; a first ML model generating probabilities 628-1 through 628-N (collectively referred to herein as “probabilities 628” and individually referred to herein as “probability 628”) for markup language elements 608; a probability density distribution generator 636 generating a probability density distribution 638, for web page 604, based on probabilities 628; and a distribution feature extractor 650 extracting distribution features 652 from probability density distribution 638.

In workflow 600, a training data instance generator 654 generates a training data instance for web page 604 based on distribution features 652. For example, a training input of the training data instance may include distribution features 652. A training output of the training data instance may include a transaction probability threshold 648 determined for the web page 604. In workflow 600, a labeled web page identifier 640 may be used to determine the transaction probability threshold 648 for web page 604.

For example, labeled web page identifier 640 may identify one or more labeled web pages from a plurality of labeled web pages that are associated with web page 604. A labeled web page may be “associated with” web page 604 where the labeled web page has a corresponding probability density distribution (or distribution features) that are similar to the probability density distribution 638 (or distribution features 652) generated for web page 604. In certain aspects, labeled web page identifier 640 identifies the one or more labeled web pages as web pages associated with the top-k (e.g., where k is an integer greater than zero) most similar probability density distributions to probability density distribution 638 generated for web page 604.

In certain aspects, labeled web page identifier 640 uses clustering techniques to identify the one or more labeled web pages. For example, labeled web page identifier 640 may cluster the probability density distribution 638 and a respective probability density distribution (shown as probability density distributions 644-1, 644-2, and 644-3 in FIG. 6) generated for each of the labeled web pages into multiple clusters. Labeled web page identifier 640 may identify a first cluster of the multiple clusters that includes probability density distribution 638. Labeled web page(s) associated with other probability density distributions included in the first cluster may be identified as the labeled web page(s) that are associated with web page 604.

In certain aspects, labeled web page identifier 640 determines a Kullback-Leibelber (KL) divergence between probability density distribution 638 and each probability density distribution (shown as probability density distributions 644-1, 644-2, and 644-3 in FIG. 6) generated for each of the labeled web pages. Labeled web page(s) associated with KL divergence value(s) that satisfy a threshold KL divergence may be identified as the labeled web page(s) that are associated with web page 604.

Each labeled web page may be associated with a transaction probability threshold (shown as transaction probability thresholds 646-1, 646-2, and 646-3 in FIG. 6). Transaction probability threshold(s) associated with labeled web page(s) determined to be associated with web page 604 may be used to determine the transaction probability threshold 648 for web page 604. For example, in certain aspects, the transaction probability threshold 648 may be computed as the as an average of the transaction probability thresholds associated with each of the labeled web page(s) determined to be associated with web page 604.

As an illustrative example, shown in FIG. 6, labeled web page identifier 640 may determine that labeled web pages, corresponding to probability density distributions 644-1 and 644-2 (and not corresponding to probability density distribution 644-3), are associated with web page 604 (e.g., their probability density distributions 644-1 and 644-2 are similar to probability density distribution 638 generated for web page 604). Thus, the transaction probability threshold 648 for web page 604 may be computed as an average of the transaction probability 646-1 and transaction probability threshold 646-2 (without including transaction probability threshold 646-3).

Training data instance generator 654 may use the transaction probability threshold 648 as the training output for the training data instance generated for web page 604.

This training data instance may be used with one or more other training data instances to train an ML model for predicting transaction probability thresholds for various web pages, such as second ML model 408 depicted and described above with respect to FIG. 4.

Thus, as illustrated in FIG. 4, supervised and unsupervised learning may be used to train a second ML model 408 to predict a transaction probability threshold for a web page (e.g., to adaptively tune a transaction probability threshold for each unique web page).

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

### Example Method for Markup Language Element Classification

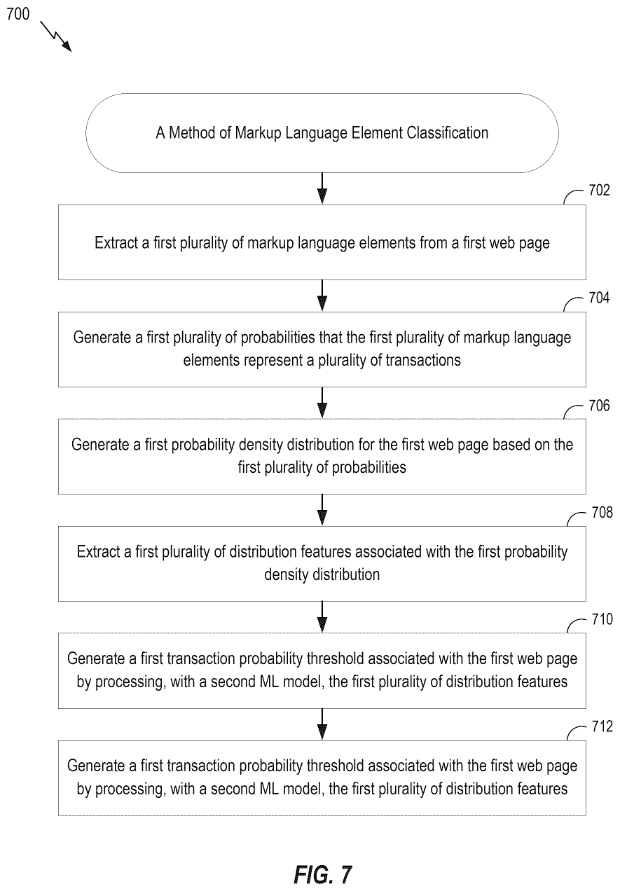

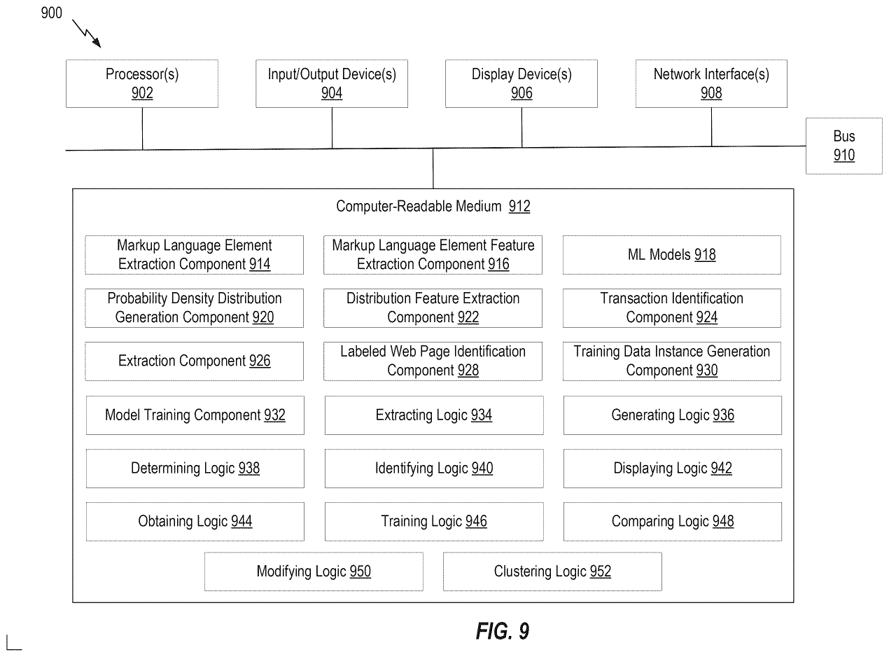

FIG. 7 depicts an example method 700 for markup language element classification, such as for web page content extraction. In one aspect, method 700 can be implemented by the system 100 of FIG. 1 and/or processing system 900 of FIG. 9.

Method 700 starts at block 702 with extracting a first plurality of markup language elements from a first web page.

Method 700 continues to block 704 with generating a first plurality of probabilities that a first plurality of HTML elements represent a plurality of transactions. In certain aspects, generating the first plurality of probabilities comprises, for each respective markup language element of the first plurality of markup language elements: determining a first plurality of markup language features associated with the respective markup language element; and generating a probability that the respective markup language element represents a transaction by processing, with a first ML model, the first plurality of markup language features.

Method 700 continues to block 706 with generating a first probability density distribution for the first web page based on the first plurality of probabilities.

Method 700 continues to block 708 with extracting a first plurality of distribution features associated with the first probability density distribution.

Method 700 continues to block 710 with generating a first transaction probability threshold associated with the first web page by processing, with a second ML model, the first plurality of distribution features.

Method 700 continues to block 712 with identifying a subset of the first plurality of markup language elements having respective probabilities above the first transaction probability threshold.

In certain aspect, method 700 further includes displaying, via a user interface, text associated with the subset of the first plurality of markup language elements.

In certain aspects, the first plurality of markup language features include at least one of: text associated with the respective markup language element; a type of the respective markup language element; a number of parent elements associated with the respective markup language element; a number of sibling elements associated with the respective markup language element; depth of the respective markup language element; a markup language path or an embedding of the markup language path associated with the respective markup language element; or a table header corresponding to the respective markup language element.

In certain aspects, the first probability density distribution comprises a kernel density estimation.

In certain aspects, the first plurality of markup language features associated with the first probability density distribution comprise at least one of: a number of peaks; one or more peak values; one or more peak positions; or an embedding of a histogram.

In certain aspects, method 700 provides several technical benefits that address challenges described above. For example, using the first and second ML models to identify transaction elements for extraction provides an alternative solution to web page content extraction, conventionally performed using web page-specific scripts. The ML models may be universally applied to any web page for content extraction, which overcomes the technical problem of limited data processing capability when using web page-specific scripts for extracting transaction information from web pages. Further, method 700 may initially predict the probability of a markup language element representing a transaction element and then further use a threshold to check whether the prediction is valid. The use of the threshold helps to control the confidence level required to consider a markup language element as an element that contains desired content for extraction, thereby resulting in improved extraction accuracy.

Note that FIG. 7 is just one example of a method, and other methods including fewer, additional, or alternative operations are possible consistent with this disclosure.

### Example Method for Training an ML Model to Predict a Transaction Probability Threshold for a Web Page

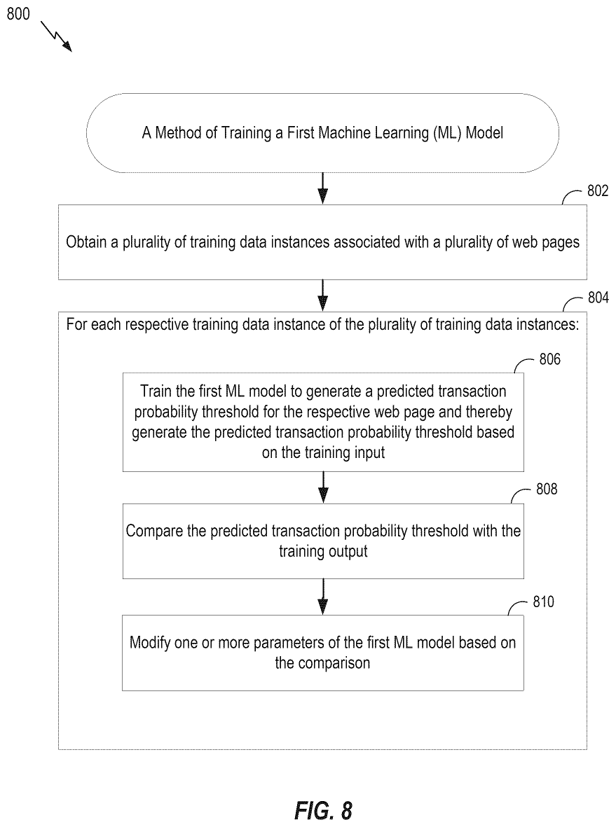

FIG. 8 depicts an example method 800 for training an ML model to predict a transaction probability threshold for a web page. In one aspect, method 800 can be implemented by the system 100 of FIG. 1 and/or processing system 900 of FIG. 9.

Method 800 starts at block 802 with obtaining a plurality of training data instances associated with a plurality of web pages. Each respective training data instance associated with a respective web page may include: a training input comprising a plurality of features associated with a probability density distribution generated for the respective web page; and a training output comprising a transaction probability threshold associated with the respective web page.

Method 800 continues to block 804 with performing steps at blocks 806-810 for each respective training data instance of the plurality of training data instances.

For example, method 800 continues to block 806 with training the first ML model to generate a predicted transaction probability threshold for the respective web page and thereby generate the predicted transaction probability threshold based on the training input.

Method 800 continues to block 808 with comparing the predicted transaction probability threshold with the training output.

Method 800 continues to block 810 with modifying one or more parameters of the first ML model based on the comparison.

In certain aspects, obtaining the plurality of training data instances at block 802 includes generating a first training data instance associated with a first web page of the plurality of web pages. Generating a first training data instance may comprise: extracting a first plurality of markup language elements from the first web page; and generating a first plurality of probabilities that the first plurality of markup language elements represent a plurality of transactions; generating a first probability density distribution for the first web page based on the first plurality of probabilities; identifying one or more labeled web pages from a plurality of labeled web pages that are associated with the first web page based on the first probability density distribution and a respective probability density distribution generated for each of the one or more labeled web pages; determining a first transaction probability threshold associated with the first web page based on a respective known transaction probability threshold associated with each of the one or more labeled web pages; generating a first training input, for the first training data instance, comprising a first plurality of distribution features associated with the first probability density distribution; and generating a first training output, for the first training data instance, comprising the first transaction probability threshold. In certain aspects, generating the first plurality of probabilities that the first plurality of markup language elements represent the plurality of transactions comprises, for each respective markup language element of the first plurality of markup language elements: determining a plurality of markup language features associated with the respective markup language element; and generating a probability that the respective markup language element represents a transaction by processing, with a second ML model, the plurality of markup language features

In certain aspects, identifying the one or more labeled web pages includes: clustering the first probability density distribution and a respective probability density distribution generated for each of the plurality of labeled web pages into a plurality of clusters; identifying a first cluster of the plurality of cluster comprising the first probability density distribution; and identifying the one or more labeled web pages as a subset of the plurality of labeled web pages associated with a respective probability density distribution included in the first cluster.

In certain aspects, identifying the one or more labeled web pages includes: determining a KL divergence between the first probability density distribution and each respective probability density distribution generated for each of the plurality of labeled web pages; and identifying the one or more labeled web pages based on the respective KL divergence associated with each of the one or more labeled web pages satisfying a threshold KL divergence.

In certain aspects, determining the first transaction probability threshold includes computing the first transaction probability threshold as an average of the respective known transaction probability threshold associated with each of the one or more labeled web pages.

In certain aspects, the plurality of markup language features include at least one of: text associated with the respective markup language element; a type of the respective markup language element; a number of parents associated with the respective markup language element; a number of siblings associated with the respective markup language element; depth of the respective markup language element; a markup language path or an embedding of the markup language path associated with the respective markup language element; or a table header corresponding to the respective markup language element.

In certain aspects, the first probability density distribution comprises a kernel density estimation.

In certain aspects, the first plurality of distribution features associated with the first probability density distribution include at least one of: a number of peaks; one or more peak values; one or more peak positions; or an embedding of a histogram.

In certain aspects, method 800 provides several technical benefits that address challenges described above. For example, training an ML model to predict a transaction probability threshold for a web page provides an alternative solution to using a fixed transaction probability threshold for transaction extraction. Adapting the transaction probability threshold per web page based on features associated with each web page may allow for increased transaction extraction accuracy from variant web pages.

Note that FIG. 8 is just one example of a method, and other methods including fewer, additional, or alternative operations are possible consistent with this disclosure.

### Example Processing System for Web Page Content Extraction

FIG. 9 depicts an example processing system 900 configured to perform various aspects described herein, including, for example, method 700 as described above with respect to FIG. 7 and/or method 800 as described above with respect to FIG. 8.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain aspects, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various aspects, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes markup language element extraction component 914, markup language element feature extraction component 916, ML models 918, probability density distribution generation component 920, distribution feature extraction component 922, transaction identification component 924, extraction component 926, labeled web page identification component 928, training data instance generation component 930, model training component 932, extracting logic 934, generating logic 936, determining logic 938, identifying logic 940, displaying logic 942, obtaining logic 944, training logic 946, comparing logic 948, modifying logic 950, and clustering logic 952.

In certain aspects, extracting logic 934 includes logic for extracting a first plurality of markup language elements from a first web page. In certain aspects, extracting logic 934 includes logic for extracting a first plurality of distribution features associated with the first probability density distribution. In certain aspects, extracting logic 934 includes logic for extracting a first plurality of markup language elements from the first web page.

In certain aspects, generating logic 936 includes logic for generating a first plurality of probabilities that the first plurality of markup language elements represent a plurality of transactions. In certain aspects, generating logic 936 includes logic for generating a probability that the respective markup language element represents a transaction by processing, with a first ML model, the first plurality of markup language features. In certain aspects, generating logic 936 includes logic for generating a first probability density distribution for the first web page based on the first plurality of probabilities. In certain aspects, generating logic 936 includes logic for generating a first transaction probability threshold associated with the first web page by processing, with a second ML model, the first plurality of distribution features. In certain aspects, generating logic 936 includes logic for generating a first plurality of probabilities that the first plurality of markup language elements represent a plurality of transactions. In certain aspects, generating logic 936 includes logic for generating a probability that the respective markup language element represents a transaction by processing, with a second ML model, the plurality of markup language features. In certain aspects, generating logic 936 includes logic for generating a first probability density distribution for the first web page based on the first plurality of probabilities. In certain aspects, generating logic 936 includes logic for generating a first training input, for the first training data instance, comprising a first plurality of distribution features associated with the first probability density distribution. In certain aspects, generating logic 936 includes logic for generating a first training output, for the first training data instance, comprising the first transaction probability threshold.

In certain aspects, determining logic 938 includes logic for determining a first plurality of markup language features associated with the respective markup language element. In certain aspects, determining logic 938 includes logic for determining a plurality of markup language features associated with the respective markup language element. In certain aspects, determining logic 938 includes logic for determining a first transaction probability threshold associated with the first web page based on a respective known transaction probability threshold associated with each of the one or more labeled web pages. In certain aspects, determining logic 938 includes logic for determining a KL divergence between the first probability density distribution and each respective probability density distribution generated for each of the plurality of labeled web pages.

In certain aspects, identifying logic 940 includes logic for identifying a subset of the first plurality of markup language elements having respective probabilities above the first transaction probability threshold. In certain aspects, identifying logic 940 includes logic for identifying one or more labeled web pages from a plurality of labeled web pages that are associated with the first web page based on the first probability density distribution and a respective probability density distribution generated for each of the one or more labeled web pages. In certain aspects, identifying logic 940 includes logic for identifying a first cluster of the plurality of cluster comprising the first probability density distribution. In certain aspects, identifying logic 940 includes logic for identifying the one or more labeled web pages as a subset of the plurality of labeled web pages associated with a respective probability density distribution included in the first cluster. In certain aspects, identifying logic 940 includes logic for identifying the one or more labeled web pages based on the respective KL divergence associated with each of the one or more labeled web pages satisfying a threshold KL divergence.

In certain aspects, displaying logic 942 includes logic for displaying, via a user interface, text associated with the subset of the first plurality of markup language elements.

In certain aspects, obtaining logic 944 includes logic for obtaining a plurality of training data instances associated with a plurality of web pages.

In certain aspects, training logic 946 includes logic for training the first ML model to generate a predicted transaction probability threshold for the respective web page and thereby generate the predicted transaction probability threshold based on the training input.

In certain aspects, comparing logic 948 includes logic for comparing the predicted transaction probability threshold with the training output.

In certain aspects, modifying logic 950 includes logic for modifying one or more parameters of the first ML model based on the comparison.

In certain aspects, clustering logic 952 includes logic for clustering the first probability density distribution and a respective probability density distribution generated for each of the plurality of labeled web pages into a plurality of clusters.

Note that FIG. 9 is just one example of a processing system consistent with aspects described herein, and other processing systems having additional, alternative, or fewer components are possible consistent with this disclosure.

### Example Clauses

Implementation examples are described in the following numbered clauses:
Clause 1: A method of markup language element classification, comprising: extracting a first plurality of markup language elements from a first web page; generating a first plurality of probabilities that the first plurality of markup language elements represent a plurality of transactions based on, for each respective markup language element of the first plurality of markup language elements: determining a first plurality of markup language features associated with the respective markup language element; and generating a probability that the respective markup language element represents a transaction by processing, with a first machine learning (ML) model, the first plurality of markup language features; generating a first probability density distribution for the first web page based on the first plurality of probabilities; extracting a first plurality of distribution features associated with the first probability density distribution; generating a first transaction probability threshold associated with the first web page by processing, with a second ML model, the first plurality of distribution features; and identifying a subset of the first plurality of markup language elements having respective probabilities above the first transaction probability threshold.
Clause 2: The method of Clause 1, further comprising displaying, via a user interface, text associated with the subset of the first plurality of markup language elements.
Clause 3: The method of any one of Clauses 1-2, wherein the first plurality of markup language features comprise at least one of: text associated with the respective markup language element; a type of the respective markup language element; a number of parent elements associated with the respective markup language element; a number of sibling elements associated with the respective markup language element; depth of the respective markup language element; a markup language path or an embedding of the markup language path associated with the respective markup language element; or a table header corresponding to the respective markup language element.
Clause 4: The method of any one of Clauses 1-3, wherein the first probability density distribution comprises a kernel density estimation.
Clause 5: The method of any one of Clauses 1-4, wherein the first plurality of distribution features associated with the first probability density distribution comprise at least one of: a number of peaks; one or more peak values; one or more peak positions; or an embedding of a histogram.
Clause 6: A method of training a first machine learning (ML) model, comprising: obtaining a plurality of training data instances associated with a plurality of web pages, wherein each respective training data instance associated with a respective web page comprises: a training input comprising a plurality of features associated with a probability density distribution generated for the respective web page; and a training output comprising a transaction probability threshold associated with the respective web page; for each respective training data instance of the plurality of training data instances: training the first ML model to generate a predicted transaction probability threshold for the respective web page and thereby generate the predicted transaction probability threshold based on the training input; comparing the predicted transaction probability threshold with the training output; and modifying one or more parameters of the first ML model based on the comparison.
Clause 7: The method of Clause 6, wherein obtaining the plurality of training data instances comprises generating a first training data instance associated with a first web page of the plurality of web pages based on: extracting a first plurality of markup language elements from the first web page; generating a first plurality of probabilities that the first plurality of markup language elements represent a plurality of transactions based on, for each respective markup language element of the first plurality of markup language elements: determining a plurality of markup language features associated with the respective markup language element; and generating a probability that the respective markup language element represents a transaction by processing, with a second ML model, the plurality of markup language features; generating a first probability density distribution for the first web page based on the first plurality of probabilities; identifying one or more labeled web pages from a plurality of labeled web pages that are associated with the first web page based on the first probability density distribution and a respective probability density distribution generated for each of the one or more labeled web pages; determining a first transaction probability threshold associated with the first web page based on a respective known transaction probability threshold associated with each of the one or more labeled web pages; generating a first training input, for the first training data instance, comprising a first plurality of distribution features associated with the first probability density distribution; and generating a first training output, for the first training data instance, comprising the first transaction probability threshold.
Clause 8: The method of Clause 7, wherein identifying the one or more labeled web pages comprises: clustering the first probability density distribution and a respective probability density distribution generated for each of the plurality of labeled web pages into a plurality of clusters; identifying a first cluster of the plurality of cluster comprising the first probability density distribution; and identifying the one or more labeled web pages as a subset of the plurality of labeled web pages associated with a respective probability density distribution included in the first cluster.
Clause 9: The method of any one of Clauses 7-8, wherein identifying the one or more labeled web pages comprises: determining a Kullback-Leibler (KL) divergence between the first probability density distribution and each respective probability density distribution generated for each of the plurality of labeled web pages; and identifying the one or more labeled web pages based on the respective KL divergence associated with each of the one or more labeled web pages satisfying a threshold KL divergence.
Clause 10: The method of any one of Clauses 7-9, wherein determining the first transaction probability threshold comprises computing the first transaction probability threshold as an average of the respective known transaction probability threshold associated with each of the one or more labeled web pages.
Clause 11: The method of any one of Clauses 7-10, wherein the plurality of markup language features comprise at least one of: text associated with the respective markup language element; a type of the respective markup language element; a number of parents associated with the respective markup language element; a number of siblings associated with the respective markup language element; depth of the respective markup language element; a markup language path or an embedding of the markup language path associated with the respective markup language element; or a table header corresponding to the respective markup language element.
Clause 12: The method of any one of Clauses 7-11, wherein the first probability density distribution comprises a kernel density estimation.
Clause 13: The method of any one of Clauses 7-12, wherein the first plurality of distribution features associated with the first probability density distribution comprise at least one of: a number of peaks; one or more peak values; one or more peak positions; or an embedding of a histogram.
Clause 14: A processing system, comprising: a memory comprising computer-executable instructions; and a processor configured to execute the computer-executable instructions and cause the processing system to perform a method in accordance with any one of Clauses 1-13.
Clause 15: A processing system, comprising means for performing a method in accordance with any one of Clauses 1-13.
Clause 16: A non-transitory computer-readable medium storing program code for causing a processing system to perform the steps of any one of Clauses 1-13.
Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of markup language element classification, comprising:
extracting a first plurality of markup language elements from a first web page;
generating a first plurality of probabilities that the first plurality of markup language elements represent a plurality of transactions based on, for each respective markup language element of the first plurality of markup language elements:
determining a first plurality of markup language features associated with the respective markup language element; and
generating a probability that the respective markup language element represents a transaction by processing, with a first machine learning (ML) model, the first plurality of markup language features;
generating a first probability density distribution for the first web page based on the first plurality of probabilities;
extracting a first plurality of distribution features associated with the first probability density distribution;
generating a first transaction probability threshold associated with the first web page by processing, with a second ML model, the first plurality of distribution features; and
identifying a subset of the first plurality of markup language elements having respective probabilities above the first transaction probability threshold.

2. The method of claim 1, further comprising displaying, via a user interface, text associated with the subset of the first plurality of markup language elements.

3. The method of claim 1, wherein the first plurality of markup language features comprise at least one of:
text associated with the respective markup language element;
a type of the respective markup language element;
a number of parent elements associated with the respective markup language element;
a number of sibling elements associated with the respective markup language element;
depth of the respective markup language element;
a markup language path or an embedding of the markup language path associated with the respective markup language element; or
a table header corresponding to the respective markup language element.

4. The method of claim 1, wherein the first probability density distribution comprises a kernel density estimation.

5. The method of claim 1, wherein the first plurality of distribution features associated with the first probability density distribution comprise at least one of:
a number of peaks;
one or more peak values;
one or more peak positions; or
an embedding of a histogram.

6. A method of training a first machine learning (ML) model, comprising:
obtaining a plurality of training data instances associated with a plurality of web pages, wherein each respective training data instance associated with a respective web page comprises:
a training input comprising a plurality of features associated with a probability density distribution generated for the respective web page; and
a training output comprising a transaction probability threshold associated with the respective web page;
for each respective training data instance of the plurality of training data instances:
training the first ML model to generate a predicted transaction probability threshold for the respective web page and thereby generate the predicted transaction probability threshold based on the training input;
comparing the predicted transaction probability threshold with the training output; and
modifying one or more parameters of the first ML model based on the comparison.

7. The method of claim 6, wherein obtaining the plurality of training data instances comprises generating a first training data instance associated with a first web page of the plurality of web pages based on:
extracting a first plurality of markup language elements from the first web page;
generating a first plurality of probabilities that the first plurality of markup language elements represent a plurality of transactions based on, for each respective markup language element of the first plurality of markup language elements:
determining a plurality of markup language features associated with the respective markup language element; and
generating a probability that the respective markup language element represents a transaction by processing, with a second ML model, the plurality of markup language features;
generating a first probability density distribution for the first web page based on the first plurality of probabilities;
identifying one or more labeled web pages from a plurality of labeled web pages that are associated with the first web page based on the first probability density distribution and a respective probability density distribution generated for each of the one or more labeled web pages;
determining a first transaction probability threshold associated with the first web page based on a respective known transaction probability threshold associated with each of the one or more labeled web pages;
generating a first training input, for the first training data instance, comprising a first plurality of distribution features associated with the first probability density distribution; and
generating a first training output, for the first training data instance, comprising the first transaction probability threshold.

8. The method of claim 7, wherein identifying the one or more labeled web pages comprises:
clustering the first probability density distribution and a respective probability density distribution generated for each of the plurality of labeled web pages into a plurality of clusters;
identifying a first cluster of the plurality of cluster comprising the first probability density distribution; and
identifying the one or more labeled web pages as a subset of the plurality of labeled web pages associated with a respective probability density distribution included in the first cluster.

9. The method of claim 7, wherein identifying the one or more labeled web pages comprises:
determining a Kullback-Leibler (KL) divergence between the first probability density distribution and each respective probability density distribution generated for each of the plurality of labeled web pages; and
identifying the one or more labeled web pages based on the respective KL divergence associated with each of the one or more labeled web pages satisfying a threshold KL divergence.

10. The method of claim 7, wherein determining the first transaction probability threshold comprises computing the first transaction probability threshold as an average of the respective known transaction probability threshold associated with each of the one or more labeled web pages.

11. The method of claim 7, wherein the plurality of markup language features comprise at least one of:
text associated with the respective markup language element;
a type of the respective markup language element;
a number of parents associated with the respective markup language element;
a number of siblings associated with the respective markup language element;
depth of the respective markup language element;
a markup language path or an embedding of the markup language path associated with the respective markup language element; or
a table header corresponding to the respective markup language element.

12. The method of claim 7, wherein the first probability density distribution comprises a kernel density estimation.

13. The method of claim 7, wherein the first plurality of distribution features associated with the first probability density distribution comprise at least one of:
a number of peaks;
one or more peak values;
one or more peak positions; or
an embedding of a histogram.

14. A processing system, comprising: a memory comprising computer-executable instructions; and a processor configured to execute the computer-executable instructions and cause the processing system to:
extract a first plurality of markup language elements from a first web page;
generate a first plurality of probabilities that the first plurality of markup language elements represent a plurality of transactions based on, for each respective markup language element of the first plurality of markup language elements:
determining a first plurality of markup language features associated with the respective markup language element; and
generating a probability that the respective markup language element represents a transaction by processing, with a first machine learning (ML) model, the first plurality of markup language features;
generate a first probability density distribution for the first web page based on the first plurality of probabilities;
extract a first plurality of distribution features associated with the first probability density distribution;
generate a first transaction probability threshold associated with the first web page by processing, with a second ML model, the first plurality of distribution features; and
identify a subset of the first plurality of markup language elements having respective probabilities above the first transaction probability threshold.

15. The processing system of claim 14, wherein the processor is configured to execute the computer-executable instructions and cause the processing system to display, via a user interface, text associated with the subset of the first plurality of markup language elements.

16. The processing system of claim 14, wherein the first plurality of markup language features comprise at least one of:
text associated with the respective markup language element;
a type of the respective markup language element;
a number of parent elements associated with the respective markup language element;
a number of sibling elements associated with the respective markup language element;
depth of the respective markup language element;
a markup language path or an embedding of the markup language path associated with the respective markup language element; or
a table header corresponding to the respective markup language element.

17. The processing system of claim 14, wherein the first probability density distribution comprises a kernel density estimation.

18. The processing system of claim 14, wherein the first plurality of markup language features associated with the first probability density distribution comprise at least one of:
a number of peaks;
one or more peak values;
one or more peak positions; or
an embedding of a histogram.
